(19) United States
(12) Patent Application Publication
(10) Pub. No.: US 2026/0000981 A1
(43) Pub. Date: Jan. 1, 2026

(54) INTERRUPT NOTIFICATION PROVIDED TO COMMUNICATOR INDICATING PLAYER RECEPTIVENESS TO COMMUNICATION

(71) Applicant: Sony Interactive Entertainment Inc., Tokyo (JP)

(72) Inventor: Joseph Sommer, San Mateo, CA (US)

(21) Appl. No.: 18/761,289

(22) Filed: Jul. 1, 2024

(51) Int. Cl. A63F 13/537

(52) U.S. Cl. CPC A63F 13/537

(57) ABSTRACT

A method for indicating receptiveness of a player of a video game to incoming communication is provided, including: monitoring gameplay activity occurring in the video game; monitoring activity of the player during the video game; using the monitored gameplay activity and the monitored activity of the player to determine a level of receptiveness of the player to incoming communication; rendering a visual indicator that is responsive to the level of receptiveness of the player.

### BACKGROUND OF THE INVENTION

Modern video games are capable of delivering highly engaging and immersive experiences. Accordingly, a player may at times be very immersed and focused on the video game, and it may not be desirable to attempt to communicate with the player during such times, as the player may not be receptive to communication at such times. However, at other times, the player may be less focused on the video game, and it may actually be a good time to communication with the player. Hence, it can be difficult for the communicator to determine when is an appropriate time to communicate with the player.

It is in this context that implementations of the disclosure arise.

### SUMMARY OF THE INVENTION

Implementations of the present disclosure include methods, systems and devices for providing an interrupt notification to a communicator indicating player receptiveness to communication.

In some implementations, a method for indicating receptiveness of a player of a video game to incoming communication is provided, including: monitoring gameplay activity occurring in the video game; monitoring activity of the player during the video game; using the monitored gameplay activity and the monitored activity of the player to determine a level of receptiveness of the player to incoming communication; rendering a visual indicator that is responsive to the level of receptiveness of the player.

In some implementations, monitoring gameplay activity includes monitoring gameplay audio generated from the video game.

In some implementations, monitoring gameplay activity includes monitoring gameplay video generated from execution of the video game.

In some implementations, monitoring gameplay activity includes analyzing game state data to identify events occurring in the video game.

In some implementations, monitoring activity of the player includes monitoring inputs generated from a controller device operated by the player.

In some implementations, monitoring activity of the player includes analyzing motion data indicative of movements of the player.

In some implementations, rendering the visual indicator is defined by activating a light worn by the player.

In some implementations, activating the light includes responsively setting a color of the light based on the level of receptiveness.

In some implementations, the level of receptiveness is configured to be inversely correlated to an amount of engagement of the player.

In some implementations, the method further includes: training a machine learning model; wherein determining the level of receptiveness includes applying the machine learning model to the monitored gameplay activity and the monitored activity of the player.

In some implementations, the machine learning model is trained using data describing prior instances of the video game and communications occurring during the prior instances of the video game.

In some implementations, non-transitory computer-readable medium is provided, having program instructions embodied thereon that, when executed by at least one computing device, cause said at least computing device to perform a method for indicating receptiveness of a player of a video game to incoming communication, the method including: monitoring gameplay activity occurring in the video game; monitoring activity of the player during the video game; using the monitored gameplay activity and the monitored activity of the player to determine a level of receptiveness of the player to incoming communication; rendering a visual indicator that is responsive to the level of receptiveness of the player.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates a player/user 100 engaged in gameplay of a video game executed by a game machine 102.

FIG. 2 conceptually illustrates a game scene of a video game, in accordance with implementations of the disclosure.

FIG. 3 conceptually illustrates training a model to determine the receptiveness of a player of a video game to communication, in accordance with implementations of the disclosure.

FIG. 4 conceptually illustrates a system in which the video game provides information regarding the intensity of a game scene, in accordance with implementations of the disclosure.

FIG. 5 illustrates a method for indicating a player's receptiveness to incoming communication during gameplay of a video game, in accordance with implementations of the disclosure.

FIG. 6 illustrates components of an example device 600 that can be used to perform aspects of the various embodiments of the present disclosure.

### DETAILED DESCRIPTION OF THE INVENTION

Implementations of the present disclosure include methods, systems, and devices for providing an interrupt notification to a communicator indicating player receptiveness to communication.

In some implementations, game context analysis is performed on game play of a video game by a player to present visual cues (e.g. LED lighting) to a communicator indicating windows of opportunity for interrupting the player. In some implementations, degrees of player engagement with the video game can also be provided (e.g. red, yellow, green colors indicating levels of player engagement). In some implementations, lighting may be flashing with a frequency indicating intensity of player engagement with the video game.

For remote communicators, such as when playing in a multi-player gaming session, instead of LED lighting on headgear of the player, an informational display may be shown with the different players on a team and a corresponding icon for each player indicating windows of opportunity for interrupting the corresponding player.

In some implementations, an artificial intelligence (AI) model can be trained to recognize player intensity/concentration during game play and/or windows of opportunity for interrupting the player.

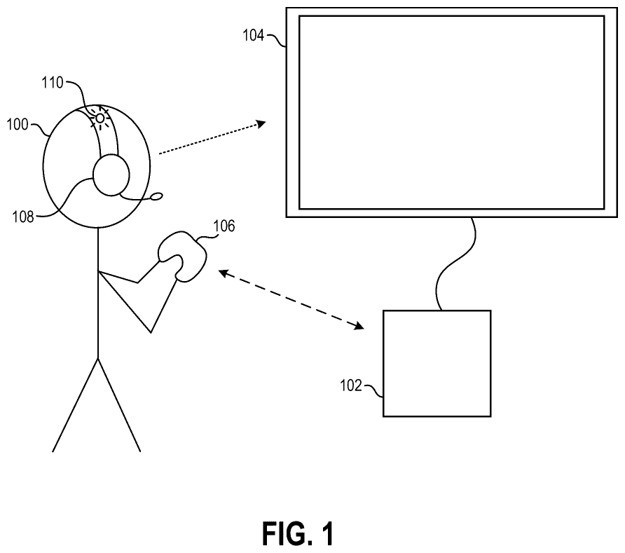

FIG. 1 conceptually illustrates a player/user 100 engaged in gameplay of a video game executed by a game machine 102. The gameplay video generated from execution of the video game is rendered for presentation on a display 104, which in some implementations, can be integrated with the game machine 102. Gameplay audio generated from the executing video game is presented through headphones 108 worn by the player 100 in the illustrated implementation, but may be presented through other types of speakers, which may be integrated with other devices such as the display 104. The player 100 may provide input by operating a controller device 106 that communicates with the game machine 102. Examples of game machine 102 include any computing device capable of executing a video game, such as a game console, personal computer, laptop, tablet, mobile device, portable gaming device, etc. Examples of display 104 include a television, monitor, integrated display, head-mounted display (or virtual reality headset), etc. Examples of controller device 106 include a game controller, keyboard, mouse, touchpad, touchscreen, motion controller/sensor, camera, microphone, or other input device.

As the player 100 is engaged in gaming, it can be difficult for another person in the local environment to ascertain whether it is a good time to communicate with the player 100, as the intensity of the game may be higher or lower at various points and the player 100 may at times be more focused or less focused on the video game. Accordingly, in some implementations, a visual indicator 110 is provided to indicate the receptiveness of the player 100 to incoming communication. In some implementations, the visual indicator 110 is in the form of one or more lights (e.g. LED(s)) or a display that is mounted on, or integrated with, the headphones 108. While a single visual indicator 110 is shown for ease of description, it will be appreciated that in various implementations there can be multiple visual indicators.

In accordance with implementations of the disclosure, the visual indicator 110 is controlled so as to responsively indicate the receptiveness of the player 100 to incoming communication. For example, in some implementations, the visual indicator 110 is configured to be illuminated in different/variable colors to indicate different or varying levels/amounts of receptiveness to communication. As an example, the visual indicator 110 can be illuminated in various colors such as green, yellow, and red colors, with green indicating the player is currently engaged in low intensity of gameplay and should therefore be highly receptive to communications, yellow indicating the player is engaged in medium intensity gameplay and therefore likely to be somewhat receptive to communications, and red indicating the player is engaged in high intensity gameplay and therefore not likely to be receptive to communications. In some implementations, the colors can be continuously variable across a range or spectrum of colors to indicate a continuously variable level of receptiveness. So for example in the present green/yellow/red embodiment, an orange color that is between yellow and red would indicate a level of receptiveness between that corresponding to the yellow and red colors.

In other implementations, other types of variable control of the indicator can be used to indicate variable levels of receptiveness to communication and/or variable levels of intensity. For example, in some implementations, flashing or pulsing of the visual indicator 110 can be used, such that the speed of flashing is positively correlated to levels of gaming intensity/concentration, and inversely correlated to receptiveness to communication.

In some implementations, the visual indicator 110 is in the form of a bar indicator or other variable display indicator, that is configurable to indicate the level or amount of receptiveness to communication of the player, and/or the level or amount of engagement/concentration on, or intensity of, gameplay that the player is currently experiencing. By providing a visual indicator 110 that indicates the player's receptiveness to communication, another person can determine whether it is a good time or not to communicate with the player 100, without actually having to interrupt the player 100 in order to find out.

While in the illustrated implementation the player 100 is wearing headphones having the visual indicator 110, in another implementation, the visual indicator can be included in a head-mounted display (HMD) worn by the player, which may be used to provide virtual reality (AR), augmented reality (AR) or mixed reality experiences.

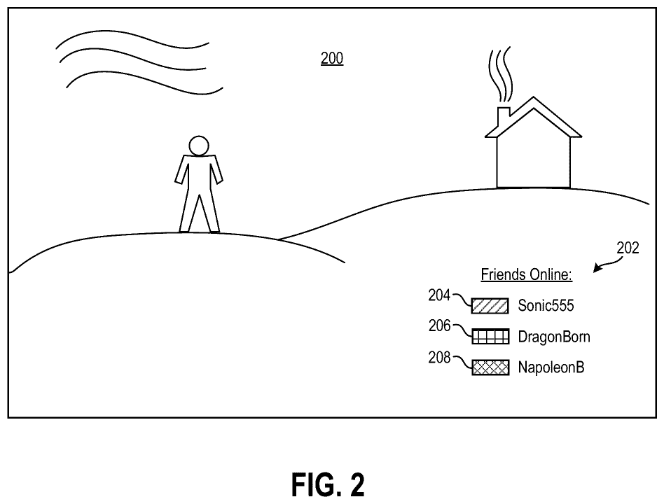

FIG. 2 conceptually illustrates a game scene of a video game, in accordance with implementations of the disclosure.

For a situation in which a remote communicator may wish to communicate with a player, such as in a multi-player video game in which the players are remotely situated from each other, a receptiveness indicator can be provided in the context of the communicator's view. For example, in the illustrated implementation, a game scene 200 of a video game as viewed by a user (e.g. a player or spectator of the video game) is shown. Overlaid on the scene is a listing 202 of user names of other users, who may be players in the same video game or in other video games in some implementations. Accompanying the user names of the players in the listing 202 are indicators configured to indicate the receptiveness of the players to communication. For example, the indicator 204 indicates the receptiveness of a user “Sonic555,” whereas the indicator 206 indicates the receptiveness of a user “DragonBorn,” whereas the indicator 208 indicates the receptiveness of a user “NapoleonB.”

It will be appreciated that the indicators 204, 206, and 208 can be configured to indicate receptiveness of the user to incoming communication, such as by using varying colors, patterns, flashing or pulsing patterns, movements, animations, etc. In some implementations, the indicators can include descriptive words, numbers, or symbols.

Alternatively, indicators are configured to indicate the level of intensity of gameplay that the user is currently experiencing, or the level of concentration that the player is currently exhibiting.

By way of example without limitation, the indicator 204 may be configured to indicate that user “Sonic555” is currently available for communication, and either not engaged in gameplay or engaged in low intensity gameplay requiring low concentration. Whereas the indicator 206 may be configured to indicate that user “Dragonborn” is currently somewhat available for communication, and engaged in moderate intensity gameplay requiring moderate concentration. Whereas the indicator 208 may be configured to indicate that user “NapoleonB” is currently not available for communication, and engaged in high intensity gameplay requiring high concentration.

As noted, in some implementations, the listing 202 is of other players of the video game. In some implementations, the listing 202 can include friends of the instant user on the gaming platform. By providing an indicator of the communication receptiveness of a given player, both the communicator's and the player's situation can be improved, as the player is less likely to be interrupted during a time when they are not receptive to communication, and the communicator can avoid the frustration of attempting to communicate with someone who is not receptive and therefore unlikely to provide a timely response.

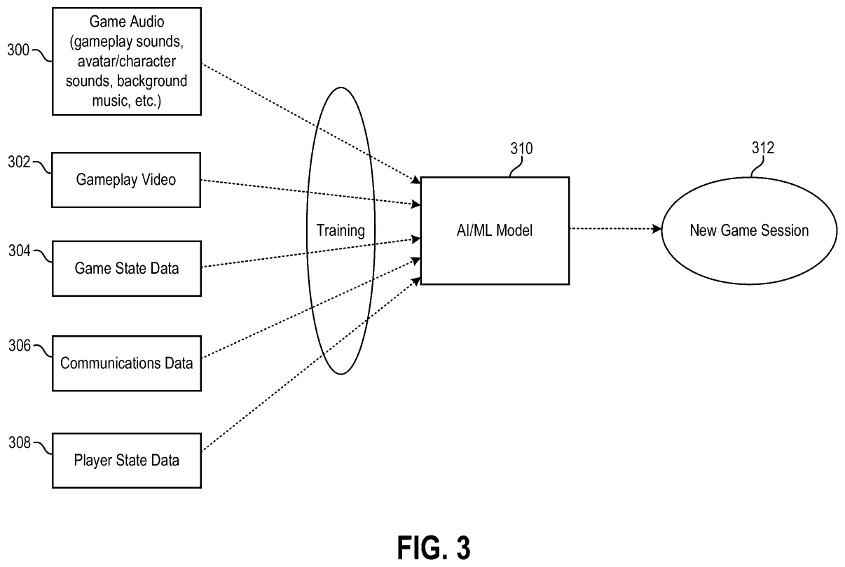

FIG. 3 conceptually illustrates training a model to determine the receptiveness of a player of a video game to communication, in accordance with implementations of the disclosure.

It will be appreciated that various information and factors can be relevant to determining how receptive a player is to communication at any given point in time. Accordingly, in some implementations, an artificial intelligence (AI) or machine learning (ML) model 310 (or other type of model) is trained to determine the receptiveness of a player to incoming communication (and/or the game intensity or concentration of the player) using various information as training data, which can be labeled training data or unlabeled training data in various implementations. The trained AI model 310 can then be applied to a new game session 312 to determine the receptiveness of the player of the new game session 312 to incoming communication.

In some implementations, game audio 300 is used to train the AI model 310 to determine the receptiveness of the player to incoming communication, and/or the game intensity or concentration of the player. For example, game audio 300 can include various kinds of sounds which are produced during gameplay, including by way of example without limitation, sounds of characters/avatars, sounds associated with objects (e.g. sounds of a vehicle, etc.), background music, background sounds, sounds indicating specific actions (e.g. weapons firing, use of particular skills/moves, etc.), sounds of players through voice chat, etc. It will be appreciated that various kinds of sounds, such as those listed, can be associated with times when the player is more or less receptive to communication.

For example, certain sounds occurring at a high rate (such as sounds associated with weapons) may indicate a high amount of activity and therefore the player may be less receptive to communication at such times. And conversely, such sounds occurring at a low rate may indicate a low amount of activity and therefore the player may be more receptive to communication at such times. In some implementations, certain background music is indicative of the scene or virtual location in which gameplay is occurring, and such may be associated with higher or lower receptiveness to communication. For example, certain background music might be associated with a boss fight in a given video game, which can be a high intensity event, and therefore such background music can be recognized and indicate that the player is likely to be less receptive to communication.

As another example, certain background music or sounds may occur when the game is paused, and this can be recognized and indicate that the player is likely to be more receptive to communication.

It will be appreciated that when a particular scene is relatively quiet, this does not necessarily mean the player is receptive to communication. For example, in a horror genre video game, a quiet scene may in fact be very intense, and not a good time to interrupt the player, and therefore the AI model 310 can be trained to recognize the sounds of such a scene as indicative of the player being less likely to be receptive to communication. Or similarly, certain points in a given video game may demand high concentration but with relative quietness in terms of sound, and thus the model 310 can be trained to recognize such sounds and associate them with less receptiveness to communication.

In some implementations, gameplay video 302 can be used to train the AI model 310, so that the AI model can recognize based on gameplay video whether the player is likely to be receptive to communication. For example, the model can be trained to recognize various aspects of gameplay from the video, such as objects, characters, avatars, actions, activities, movements, settings, backgrounds, etc., and determine the receptiveness of the player based on such recognized aspects of the video. For example, the AI model 310 may recognize when an intense scene or activity requiring a high amount of concentration is occurring, and associate such with low receptiveness to communication. Conversely, the AI model 310 can be trained to recognize when a low intensity scene or activity requiring low concentration is occurring, and associate such with high receptiveness to communication.

In some implementations, the AI model 310 can be trained on game state data 304 to determine based on the game state data of a video game the receptiveness of a player to communication. It will be appreciated that the game state data of a given video game can indicate various aspects of the video game, such as those already described, and accordingly such aspects can be recognized from the game state data and associated to varying receptiveness of the player to communication.

In some implementations, the AI model 310 is trained on communications data 306 that describes communications occurring during gameplay of a video game (e.g. communications between players, or between players and spectators/others). It will be appreciated that the amount and type of communications that occur during a given game context, can be indicative of the receptiveness of a player to communication during such a game context. That is, during game scenes where there may tend to be more communications or a higher rate of communications occurring, then a player is likely to be more receptive to communication, whereas during game scenes where there tend to be fewer communication or a lower rate of communications occurring, then a player is likely to be less receptive to communication. Accordingly, the AI model 310 can be trained to recognize such game scenes (e.g. through recognition of audio, video, game state data, etc.) as ones in which the player is likely to be more or less receptive to communication depending on the game scene. In this manner, the communications data 306, in combination with data indicative of the corresponding game scenes during which communications occur, provides an indication of the receptiveness of a player to communications throughout the various game scenes, and can be used to train the AI model 310 to determine player communication receptiveness based on game scene data accordingly. A similar concept can be applied in relation to other types of game context elements described herein, wherein the amount or rate of communications occurring simultaneous with certain game context elements can be used as an indication of player receptiveness to communication during the presence of those game context elements. And therefore, the AI model 310 can be trained to recognize and use the presence of game context elements to determine player receptiveness to incoming communication.

In some implementations, player state data 308 can be used to train the AI model 310 to determine player receptiveness to communication and/or game intensity/concentration. Player state data 308 includes data indicating the current sentiment or emotional state of the player. For example, in some implementations, a camera is used to capture images of the player, which are analyzed to determine the player's sentiment. In some implementations, biometric sensors are used to detect the player's sentiment, such as through use of a heart rate sensor, skin conductance sensor, EEG sensor, etc. It will be appreciated that the player's sentiment can indicate their receptiveness to communication, as for example, a player exhibiting higher stress levels would likely be less receptive to communications than when exhibiting lower stress levels. Accordingly, the player's sentiment can indicate the player's receptiveness to communication, and accordingly can be used to train the AI model 310 so as to determine player receptiveness to communication based on player sentiment.

In some implementations, player state data 308 includes data describing movements or other activity of the player, such as movements of the player detected from motion sensing hardware (e.g. motion controllers, HMD, etc.) and controller input activity initiated by the player. Such movement and input activity can be indicative of the player's sentiment at that moment, as a player engaged in a rapid or high rate of movements is likely under higher stress and less receptive to communication.

It will be appreciated that different users may have different capacities for handling communication under a given game context, such that some may be more receptive than others under the same context. These differences can be in a generalized sense, wherein some users can handle more communications than others across many game context situations generally, or such differences may be more specific, wherein some users are capable of handling more communications than others in certain game contexts, but not in other game contexts (wherein such users might be capable of handling less communications than the others).

Accordingly, in some implementations, the AI model 310 can be trained and/or tuned so as to be personalized to a particular user. For example, data that is specific to a given user can be used to train or tune the model so that it is capable of predicting communication receptiveness in a manner specific to that user based on game context information as presently described. In some implementations, the particular user's communications data is used to scale the receptiveness determination of the AI model 310 for that user.

Additionally, in some implementations, the AI model 310 is trained on data describing characteristics of various players, such as demographic data, data relating to the players' gaming history, activity on the gaming platform, etc. For example, players of a certain demographic profile may be more or less communicative, and thus the AI model 310 can be trained to determine player receptiveness to communication based on their demographic information. Or as another example, it may be the case that players of certain video games tend to be more communicative, and therefore the AI model 310 can be trained to determine receptiveness to communication based on the gaming history of the user, including which video games are played.

In some implementations, a cluster analysis is performed in which users are clustered based on their communications and gaming histories, and/or other data/factors described herein. And based on the determined clusters, a given user's tendencies regarding communication receptiveness can be inferred from the available information for that user. In some implementations, the model 310 is tuned for the given user according to the cluster to which they belong, so as to better determine the receptiveness of the user to communication during gameplay. Or in some implementations, a template is assigned based on the cluster to which they belong, with the template defining settings for determining user communication receptiveness based on available information.

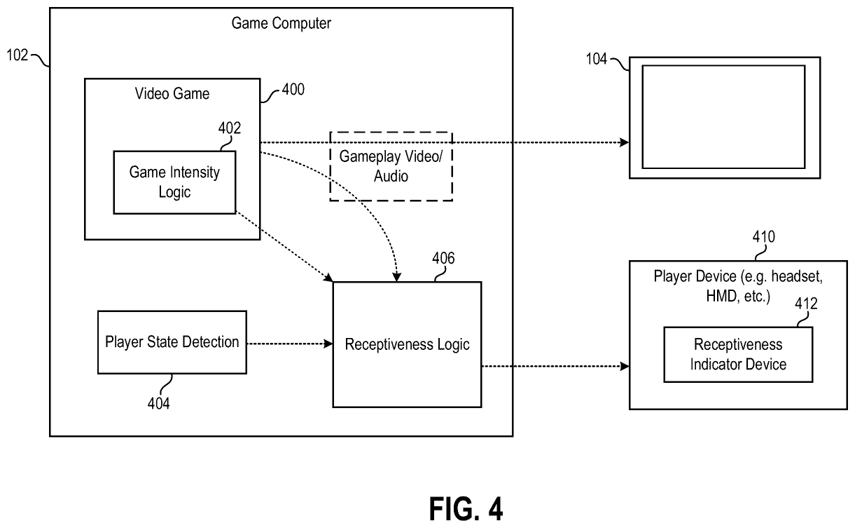

FIG. 4 conceptually illustrates a system in which the video game provides information regarding the intensity of a game scene, in accordance with implementations of the disclosure.

In the illustrated implementation, the game machine/computer 102 executes a video game 400. The game computer 102 further implements receptiveness logic 406, which is configured to determine the receptiveness of the player to incoming communication, and responsively control a receptiveness indicator device 412 (e.g. light(s), display, etc.) on a player device 410 (e.g. headphones, headset, HMD, etc.) so as to visually indicate the player's state of receptiveness to communication. To accomplish this, in some implementations, the receptiveness logic 406 implements techniques such as those presently described, including using a model to analyze gameplay audio/video, game state data, and/or other information.

In some implementations, the video game 400 itself can provide information to the receptiveness logic 406 regarding the intensity of a current game scene. That is, in some implementations, the video game 400 implements game intensity logic 402 to send information about the current state of the video game to the receptiveness logic 406, and more specifically, information describing the intensity of the current game scene or the expected concentration required on the part of the player. This information can be used by the receptiveness logic 406 to determine the player's receptiveness to communication.

By providing such information by the video game itself, certain situations which might not necessarily be determined to be high intensity situations can be more easily understood. For example, a cut scene in a video game may be important for the player to focus on watching and understanding, but the player does not perform any actions during the playback of the cut scene. During such a cut scene, the game intensity logic 402 can provide information indicating the current state as being high intensity, and accordingly, this can be used by the receptiveness logic 406 as a factor in determining the overall receptiveness of the player to communication.

In some implementations, the game computer 102 implements player state detection logic 404 to monitor and detect the current state and/or activity of the player during gameplay. This can be determined by analyzing, for example, a camera feed of the player, controller input activation/triggering by the player, sounds/speech made by the player and captured by a microphone, movements of the player, etc. As noted above, these can be indicative of the stress level or sentiment of the player, and can be used as factors to determine the receptiveness of the player to communication.

In some implementations, the system is capable of predicting the length of time that a player will be receptive to communication. For example, the player may be receptive to communication at a given moment in the gameplay, but an upcoming event such as a boss fight is likely to be a high intensity event. The system can be configured to predict the length of time available before reaching such a high intensity event, and the visual indication can be configured to indicate that the user may soon not be available for communication or even indicate the length of time expected before the user is no longer available. For example, the visual indicator may be configured to begin flashing as an indication that a high intensity event is beginning soon. Or the visual indicator can be configured to display a countdown timer or diminishing bar or hourglass graphic indicating the expected time until the player will be engaged in high intensity gameplay and therefore no longer receptive to communication.

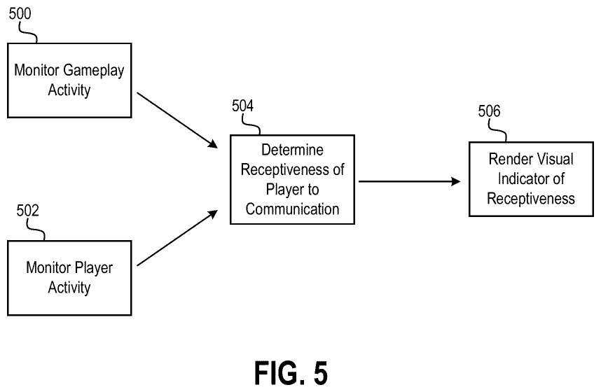

FIG. 5 illustrates a method for indicating a player's receptiveness to incoming communication during gameplay of a video game, in accordance with implementations of the disclosure.

At method operation 500, gameplay activity occurring in the video game is monitored. At method operation 502, activity of the player during the video game is monitored. At method operation 504, the monitored gameplay activity and the monitored activity of the player are used to determine a level of receptiveness of the player to incoming communication. And at operation 506, a visual indicator is rendered that is responsive to the level of receptiveness of the player to incoming communication.

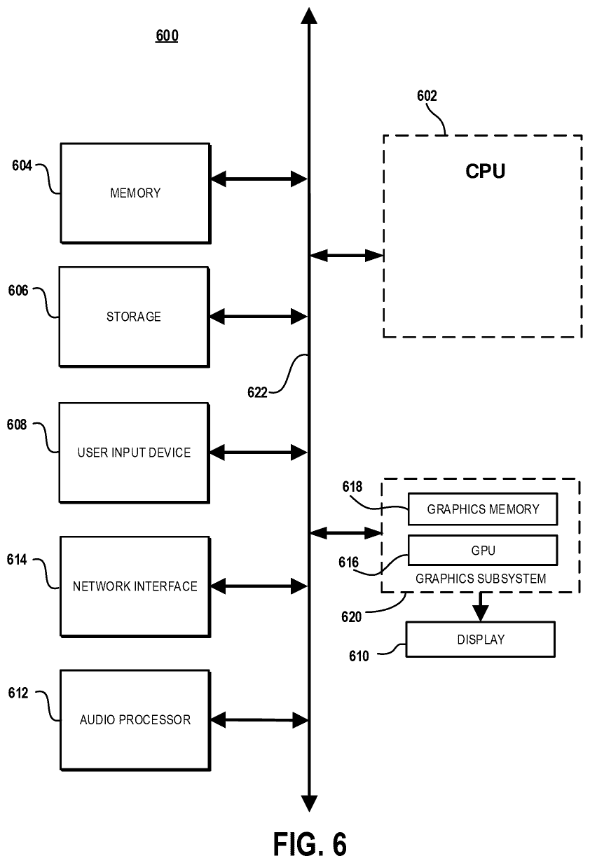

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and D-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation may be produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for indicating receptiveness of a player of a video game to incoming communication, comprising:
monitoring gameplay activity occurring in the video game;
monitoring activity of the player during the video game;
using the monitored gameplay activity and the monitored activity of the player to determine a level of receptiveness of the player to incoming communication;
rendering a visual indicator that is responsive to the level of receptiveness of the player.

2. The method of claim 1, wherein monitoring gameplay activity includes monitoring gameplay audio generated from the video game.

3. The method of claim 1, wherein monitoring gameplay activity includes monitoring gameplay video generated from execution of the video game.

4. The method of claim 1, wherein monitoring gameplay activity includes analyzing game state data to identify events occurring in the video game.

5. The method of claim 1, wherein monitoring activity of the player includes monitoring inputs generated from a controller device operated by the player.

6. The method of claim 1, wherein monitoring activity of the player includes analyzing motion data indicative of movements of the player.

7. The method of claim 1, wherein rendering the visual indicator is defined by activating a light worn by the player.

8. The method of claim 7, wherein activating the light includes responsively setting a color of the light based on the level of receptiveness.

9. The method of claim 1, wherein the level of receptiveness is configured to be inversely correlated to an amount of engagement of the player.

10. The method of claim 1, further comprising:
training a machine learning model;
wherein determining the level of receptiveness includes applying the machine learning model to the monitored gameplay activity and the monitored activity of the player.

11. The method of claim 10, wherein the machine learning model is trained using data describing prior instances of the video game and communications occurring during the prior instances of the video game.

12. A non-transitory computer-readable medium having program instructions embodied thereon that, when executed by at least one computing device, cause said at least computing device to perform a method for indicating receptiveness of a player of a video game to incoming communication, the method comprising:
monitoring gameplay activity occurring in the video game;
monitoring activity of the player during the video game;
using the monitored gameplay activity and the monitored activity of the player to determine a level of receptiveness of the player to incoming communication;
rendering a visual indicator that is responsive to the level of receptiveness of the player.

13. The non-transitory computer-readable medium of claim 12, wherein monitoring gameplay activity includes monitoring gameplay audio generated from the video game.

14. The non-transitory computer-readable medium of claim 12, wherein monitoring gameplay activity includes monitoring gameplay video generated from execution of the video game.

15. The non-transitory computer-readable medium of claim 12, wherein monitoring gameplay activity includes analyzing game state data to identify events occurring in the video game.

16. The non-transitory computer-readable medium of claim 12, wherein monitoring activity of the player includes monitoring inputs generated from a controller device operated by the player.

17. The non-transitory computer-readable medium of claim 12, wherein monitoring activity of the player includes analyzing motion data indicative of movements of the player.

18. The non-transitory computer-readable medium of claim 12, wherein rendering the visual indicator is defined by activating a light worn by the player.

19. The non-transitory computer-readable medium of claim 18, wherein activating the light includes responsively setting a color of the light based on the level of receptiveness.

20. The non-transitory computer-readable medium of claim 12, wherein the level of receptiveness is configured to be inversely correlated to an amount of engagement of the player.
